(19) United States
(12) Patent Application Publication
(10) Pub. No.: US 2004/0028139 A1
(43) Pub. Date: Feb. 12, 2004

(54) Video encoding

(76) Inventors: Andre Zaccarin, Quebec City (CA); Phillip G. Austin, Fountain Hills, AZ (US); Vivaik Balasubrawmanian, Chandler, AZ (US)

Correspondence Address: FISH & RICHARDSON, PC, 12390 EL CAMINO REAL, SAN DIEGO, CA, 92130-2081, US

(21) Appl. No.: 10/213,618

(22) Filed: Aug. 6, 2002

(51) Int. Cl. H04N 7/12

(52) U.S. Cl. 375/240.24; 375/240.01

(57) ABSTRACT

An input video sequence can be encoded at least twice. After the first encoding, the input video sequence is re-encoded as a function a previous encoding. Cycles of encoding and quality evaluation can be repeated, for example, until a predetermined constraint is satisfied. The method can be used to provide encoded video of a given quality or bit size.

### BACKGROUND

This description relates to video encoding.

Encoding can be used to compress video information, e.g., for storage or distribution.

In some compression methods, quality features of the input video sequence are analyzed, and parameters that control the extent of compression are set based on the analysis. Referring to FIG. 1, one known method of encoding video information includes analyzing an input video sequence 10 using a video preprocessor 12 that characterizes spatial blocks in the input sequence. The spatial blocks are typically a group of adjacent pixels within a frame. The video preprocessor 12 determines an encoding parameter based on its analysis and communicates the parameter to the video encoder 14. The video encoder then encodes the input video sequence 10 according to the encoding parameter to produce an encoded video sequence 16.

Video information analysis can include, for example, determining if the video image includes spatial blocks that are smooth, edged, or textured. Another analysis determines the peak signal-to-noise ratio (PSNR) for the image. Still other analyses provide an objective measure reflective of human perception. Examples of such analyses are described in Verscheure and Lambrecht “Adaptive quantization using a perceptual visibility predictor,” IEEE Proceedings of International Conference on Image Processing, Vol. 1, pp. 298-301, 1997, and Jiang et al. “A Video Transmission System Based on Human Visual Model,” IEEE Vehicular Technology Conference, Vol. 2, pp. 868-873, 1999. Standards for video quality are also described by “American National Standard for Telecommunications—Digital Transport of One-Way Video Telephony Signals—Parameters for Objective Performance Assessment” (ANSI T1.801.03, published 1996).

### BRIEF DESCRIPTION OF DRAWINGS

FIGS. 1, 2, and 4 are block diagrams.

FIG. 3 is a flow chart.

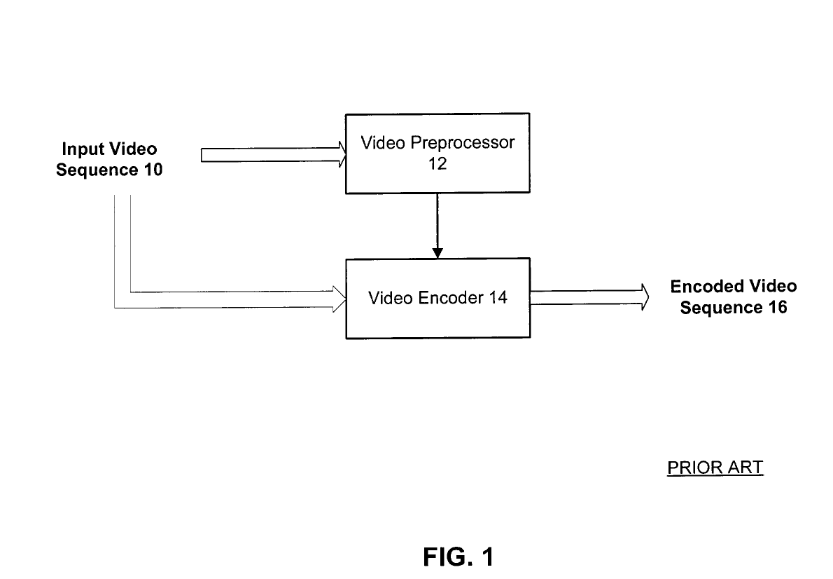

### DETAILED DESCRIPTION

An input video sequence may be encoded at least twice. After the first encoding, at least part of the input video sequence is re-encoded as a function of the quality of a previous encoding. Cycles of encoding and quality evaluation can be repeated, for example, until a predetermined constraint is satisfied.

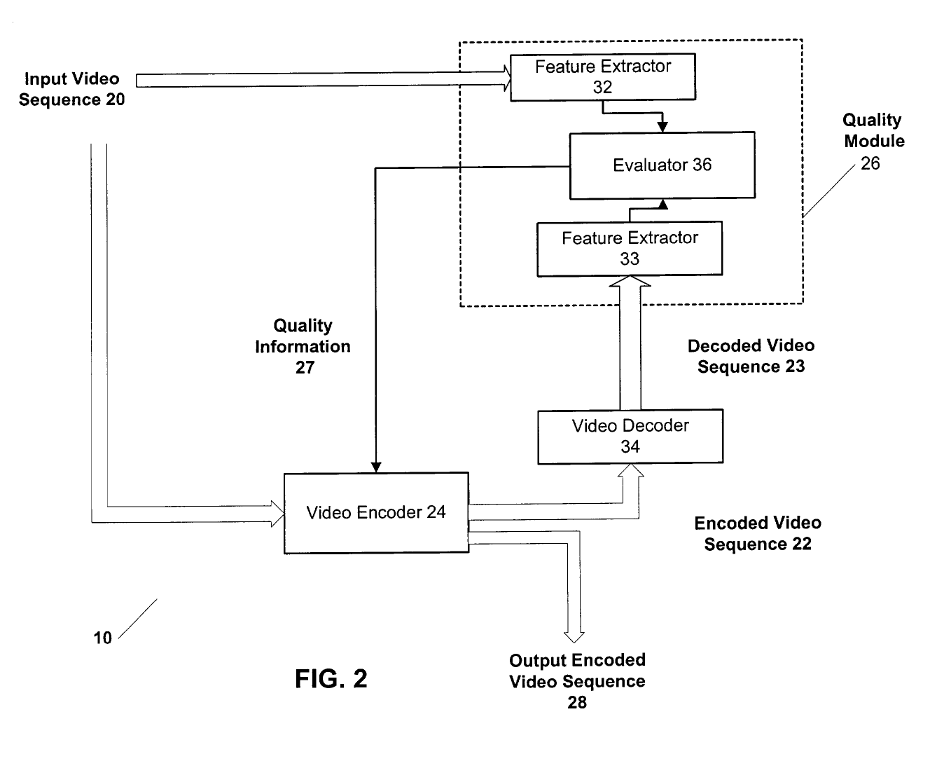

In some instances, re-encoding is applied uniformly to each entire frame. In other instances, re-encoding is restricted to a subset of blocks in one or more frames. In the latter cases, blocks within a frame can be independently optimized as different blocks with a frame are encoded to different bit sizes. Referring to FIG. 2, an exemplary system 10 for encoding an input video sequence 20 (e.g., a sequence of high quality image frames) includes a video encoder 24 and a quality module 26.

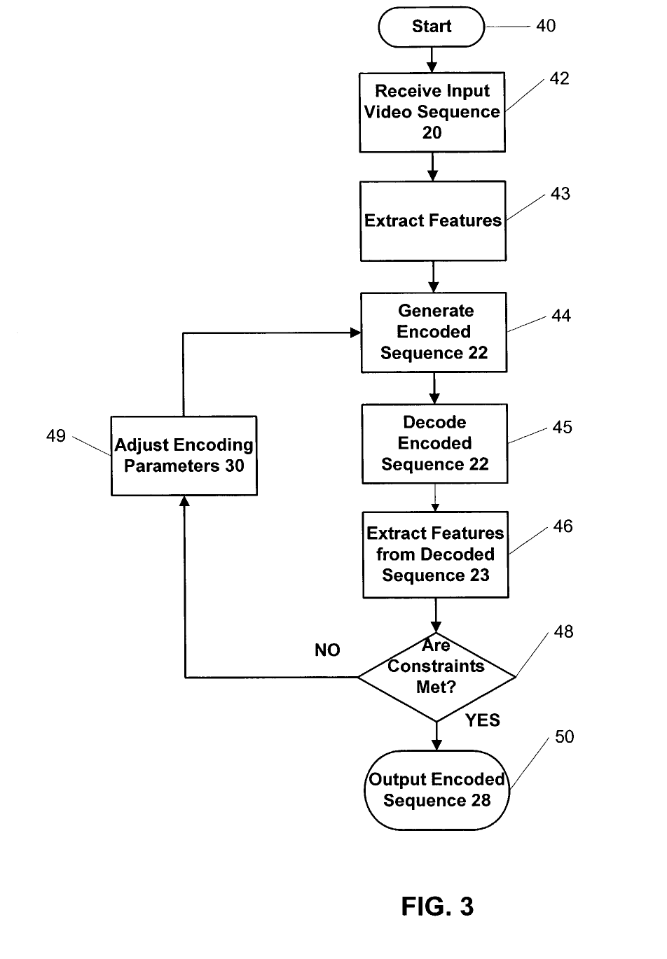

Referring also to the exemplary method in FIG. 3, the encoder 24 receives 42 a high quality input video sequence 20 and generates 44 an encoded video sequence 22 based on default parameters, typically using lossy compression. Among other factors, the quantization of pixels or transformed coefficients associated with lossy compression often results in information loss. The encoder can also use non-lossy compression. A compression method may be with or without encryption.

At least for lossy compression, decoded video sequence 23 obtained from the encoded video sequence 22 can differ from the input high quality video stream 20 and the difference can entail an observable difference for a viewer of the two streams. Accordingly, after the encoding, the encoded video sequence 22 is evaluated for quality, for example, as follows.

The encoded video sequence 22 is decoded 45 by the decoder 34 to provide decoded video sequence 23. Then the decoded video sequence is compared to the original video sequence.

Frames of each video sequence are divided into blocks, and the video quality features of each block are determined. Exemplary features include edges, roughness, and motion. The features of blocks from the original video sequence 20 are extracted 43 by the feature extractor 32 of the quality module 26. Similarly, the features of the decoded video 23 are extracted 46 by the feature extractor 33. The features of each block in the decoded video are compared by the evaluator 36 to the corresponding block in the original video 20 to generate quality information 27. Quality information 27 generated by the evaluator 36 is communicated to the video encoder 24 which can determine if a particular constraint is satisfied or if re-encoding is required.

The quality information 27 can include, for example, one or more of indicators identifying a set of blocks (e.g., least performing blocks), a matrix of results for individual blocks or frames, or an overall quality metric for a frame or set of frames.

This process of re-encoding can be repeated until one or more constraints are satisfied. Examples of predetermined constraints include: a maximum bit size (e.g., extent of compression) and a minimum quality metric. The predetermined constraint can be used to: minimize bit size given a threshold quality metric, or to maximize quality given a threshold bit size. Other constraints are possible. For example, the constraint may be a function of both bit size and quality.

The constraint can be adapted to the situation, and even changed according to user preferences or automatically, e.g., according to the content of the input video.

If the predetermined constraint is met, then the encoded video sequence is outputted 50. On the other hand, if the constraint is not satisfied, the encoding parameters are adjusted 49. Typically, the encoding parameters are automatically adjusted, e.g., using a mathematical function that depends on the quality metric of a previous encoding. For example, the encoding parameters can be incremented using a standard step value, as a function of the quality metric, or as a function of the difference between the quality of the current encoded sequence and the quality required by the constraints. Such functions can include increasingly fine adjustments as a target parameter is approached over multiple encoding cycles. The method can include encoding the input sequence at least two or at least three times, each time using a different encoding parameter.

The video encoder 24 then encodes at least part of the input video sequence 20 a second time using the altered parameters to produce a second processed video sequence. The process can be used in an iterative mode, in which case this second processed video sequence is also analyzed by the quality module 26 and the results communicated again to the video encoder 24. The iterations can continue until no further improvement is achieved or until the predetermined condition (e.g., a maximum bit size or minimum quality) is attained.

In some implementations, extracted features from the original video sequence are stored and are accessed during successive rounds of evaluation. Thus, it is only necessary to extract features from the original video sequence once. For example, as shown in FIG. 3, the features of the original video sequence can be extracted 43 prior to cycles of encoding.

Further, at least three types of models can be used to generate the quality information—a full reference model, a reduced reference model, and a single reference model. The above-described method, which uses extracted features from blocks within a frame, is an implementation of a reduced reference model. Rather than using extracted features, a full reference model generally includes direct comparison of regions of an original video sequence to corresponding regions of decoded video sequence. In contrast to both the full reference and reduced reference models, a single reference model involves analysis of the decoded video sequence without comparison to the original video sequence.

Characterization of video quality, for any model, may include determining an objective metric of video quality. For example, the peak-signal-to-noise ratio (PSNR) can be objectively determined. It is also possible to determine objective measures that are correlated with human perception. See, e.g., Verscheure and Lambrecht, supra, and Jiang et al., supra. Such objective indicia are correlated to whether a human observer would perceive the visual change caused by discarding some of the input video information.

Multiple evaluations can also be used. For example, the quality module can compute an overall quality score as a function of two or more different quality metrics. The evaluation can be applied to an entire sequence of frames, a set of one or more frames, or selected blocks within a frame or set of frames.

In some implementations, the quality module divides images into blocks, selects a set of one or more blocks, and optimizes the compression until the set of blocks satisfies a predetermined constraint. Analysis of less than the entire frame increases efficiency. The selected set of blocks can be a set of least performing blocks, e.g., blocks predicted to be most difficult to compress. In another example, the set is a representative set. In still another example, all blocks of each frame are repeatedly encoded until each block satisfies a predetermined constraint.

In some implementations, a set of least performing blocks within each frame are identified, and indicated for re-encoding using a different encoding parameter 30. In these implementations, the quality information 27 may include the addresses of the least performing blocks, and optionally an adjusted encoding parameter to use for re-encoding these blocks. In some other implementations, entire frames are re-encoded using a different encoding parameter 30. In such implementations, the quality information may include an adjusted encoding parameter 30 for re-encoding the frames.

In an alternative implementation, the quality module 26 itself adjusts the encoding parameters and communicates these, rather than quality information 27, to the video encoder 24.

In one exemplary implementation, the system 18 also analyzes the input video sequence 20 to identify sets of image frames within the sequence that should be encoded together, e.g., using the same encoding parameters. In a related implementation, the system analyzes the input sequence and other parameters to determine content and possible origin of the input sequence. Such factors can be used to configure the number of image frames that are processed using the same encoding parameters as well as an appropriate predetermined constraint. In some cases, a single frame may be processed using a particular encoding parameters. In other cases, multiple frames may be processed using a particular encoding parameter. The number of frames that are processed together can also vary.

In another exemplary implementation, the video encoder receives a stream of input video sequence. The encoder encodes a segment of the stream according to an encoding parameter that is a function of the quality of a previously encoded segment that does not overlap with the segment currently being encoded. Thus, the video encoder continuously adjusts its encoding parameters based on the success of encoding a previous segment. While this approach might not necessarily optimize the encoding of a given segment, it enables the system to alter the encoding parameter “on the fly” and without multiple cycles of re-encoding.

These encoding techniques have a variety of applications. Some examples include: compressing a video sequence for distribution (e.g., streaming) across a computer network, e.g., an internet, compressing a video sequence for archival purposes, compressing a video sequence for distribution on a storage medium (e.g., a Digital Versatile Disc (DVD)), communicating a video in real-time, e.g., video conferencing, and video broadcasting. They can also be used for encoding other visual information, e.g., still digital images and so forth.

In one test implementation, a Moving Pictures Expert Group Standard-2 (MPEG-2; “Information Technology—Generic Coding of Moving Pictures and Associated Audio.” ISO/IEC 13818, published 1994 and onwards) encoder was interfaced with a quality module. Intra-frames (I-frames) were computed for spatio-temporal blocks of 8×8 pixels X 6 frames. The software simulation found that, for the same subjective video quality, the test system achieved 15% to 25% smaller encoded sequences than a reference encoder that did not adjust coding parameters in response to the quality of a prior encoding.

The techniques described here are not limited to any particular hardware or software configuration; they may find applicability in any computing or processing environment. The techniques may be implemented in hardware, software, or a combination of the two. For example, the techniques can be implemented using embedded circuits, e.g., a circuit that includes a video encoder and/or a quality module.

In another example, the techniques may be implemented in programs executing on programmable machines such as mobile or stationary computers, handheld devices (such as mobile telephones, personal digital assistants, and cameras) and similar devices that each include a processor, a storage medium readable by the processor (including volatile and non-volatile memory and/or storage elements), at least one port or device for video input, and one or more output devices (e.g., for video storage and/or distribution).

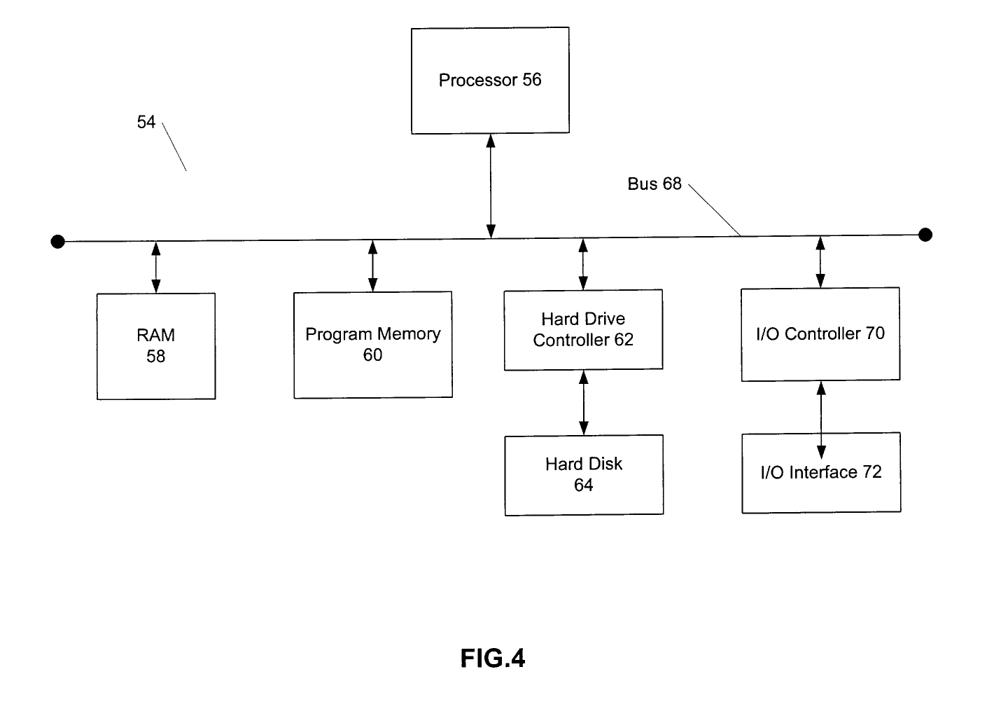

As shown in FIG. 4, an example of a programmable system 54, suitable for implementing a described video encoding method, includes a processor 56, a random access memory (RAM) 58, a program memory 60 (for example, a writable read-only memory (ROM) such as a flash ROM), a hard drive controller 62, and an input/output (I/O) controller 70 coupled by a processor (central processing unit or CPU) bus 68. The system 56 can be preprogrammed, in ROM, for example, or it can be programmed (and reprogrammed) by loading a program from another source. The hard drive controller 62 is coupled to a hard disk 64 suitable for storing executable computer programs and/or encoded video data. The I/O controller 70 is coupled to an I/O interface 72. The I/O interface 72 receives and transmits data in analog or digital form over a communication link such as a serial link, local area network, wireless link, or parallel link.

Another exemplary implementation includes a digital video camera that includes an embedded circuit or a processor programmed with software to encode input video. Video images captured by the camera are encoded using a video encoder and quality module as described above. The output sequence is recorded onto a medium or stored in memory, e.g., flash memory.

Programs may be implemented in a high-level procedural or object oriented programming language to communicate with a machine system. However, the programs can be implemented in assembly or machine language, if desired. In any case, the language may be a compiled or interpreted language. Each such program may be stored on a storage medium or device, e.g., compact disc read only memory (CD-ROM), hard disk, magnetic diskette, or similar medium or device, that is readable by a general or special purpose programmable machine for configuring and operating the machine when the storage medium or device is read by the computer to perform the procedures described in this document. The system may also be implemented as a machine-readable storage medium, configured with a program, where the storage medium so configured causes a machine to operate in a specific and predefined manner.

Although we have described particular implementations above, other implementations are also within the scope of the claims.

What is claimed is:

1. A machine-based method comprising:
evaluating first-encoded video information to determine a quality parameter, wherein the first-encoded video information comprises an encoded form of a source video information; and
encoding at least a part of the source video information as a function of the quality parameter to provide second-encoded video information.

2. The method of claim 1 wherein the evaluating comprises decoding the first-encoded video information.

3. The method of claim 1 wherein the evaluating comprises comparing information about the first-encoded video information to information about the source video information.

4. The method of claim 3 in which the information about the first-encoded video information comprises a decoded form of the first-encoded video information.

5. The method of claim 2 wherein the evaluating comprises determining an objective metric of human perception of video obtained by decoding the first-encoded video information.

6. The method of claim 1 wherein the source video information corresponds to a segment of a video sequence, the method is repeated for other source video information that represents different segments of the video sequence, and the other source video information for the different segments is encoded as a function of different respective quality parameters.

7. The method of claim 6 wherein the different segments are of variable size.

8. The method of claim 1 wherein the evaluating comprises evaluating information that corresponds to less than an entire frame for each frame of the first-encoded video information.

9. The method of claim 8 wherein evaluating comprises evaluating a subset of pixels of the frame, wherein the subset is selected based on a quality parameter for the subset.

10. The method of claim 1 wherein the encoding to provide second-encoded information is automatic.

11. The method of claim 1 further comprising repeating the method, at least twice, until a predetermined condition is met.

12. A machine-based method comprising:
repeatedly encoding video information until a predetermined condition is met; and
generating output video information.

13. The method of claim 12 wherein the method comprises at least three repeats of the encoding.

14. The method of claim 1 or 12 wherein the encoding is lossy.

15. The method of claim 12 wherein the predetermined condition comprises a threshold data size for the encoded video information.

16. The method of claim 12 wherein the predetermined condition comprises a threshold value for a quality metric of the decoded encoded video information.

17. The method of claim 12 wherein the predetermined condition comprises a threshold change in a parameter relative to a previous cycle of encoding.

18. The method of claim 12 wherein for at least one repeat of the encoding, less than an entire frame is encoded.

19. The method of claim 12 wherein each subsequent cycle of encoding comprises encoding the video information as a function of the previously encoded video information.

20. An article of machine-readable medium, having encoded thereon on instructions to cause a processor to effect a method comprising:
encoding video information; and
one or more cycles of (a) evaluating the encoded video information to determine a quality parameter; and (b) re-encoding at least a part of the video information as a function of the quality parameter.

21. The article of claim 20 wherein the cycles are repeated until a predetermined condition is satisfied.

22. The article of claim 20 wherein the quality parameter is an objective measure of human perception of a video obtained by decoding the encoded source video information.

23. A method comprising:
receiving, at a video encoder, source video information and information about encoded video information; and
encoding at least a part of the source video information as a function of the information about the encoded video information.

24. The method of claim 23 wherein the source video information and the information about the encoded video information are received at independent intervals.

25. The method of claim 23 wherein the encoded video information is an encoded form of the source video information.

26. The method of claim 23 wherein the source video information corresponds to a particular image frame or a set of image frames from a video sequence and the information about encoded video information comprises information about encoded information for a preceding image frame or preceding set of image frames from the video sequence.

27. The method of any of claims 23 to 26, wherein the information about the encoded video information comprises a quality parameter.

28. The method of claim 1 or 23 wherein one or a set of blocks from a frame represented in the source video information is encoded.

29. The method of claim 1 or 23 wherein an entire frame represented in the source video information is encoded.

30. An apparatus comprising:
a circuit to evaluate encoded video information; and
an encoder in signal communication with the circuit and comprising a processing element to encode video information as a function of a signal received from the circuit.

31. The apparatus of claim 30, wherein the circuit receives encoded video information from the encoder.

32. The apparatus of claim 30 further comprising an input and output port for communicating video information, wherein the ports are in signal communication with the encoder, and the processing element can direct the encoded video information to the output port.

33. The apparatus of claim 30 wherein the signal indicates selected blocks for encoding, the blocks being a subset of frames represented by the video information.

34. A system comprising:
a digital imaging system to generate video information;
a storage medium to store digital information; and
circuitry to encode the generated video information, wherein the circuitry is in signal communication with the digital imaging system to receive the generated video information and in signal communication with the storage medium to send encoded output video information, and wherein the circuitry is configured to repeatedly encode video information until a predetermined condition is satisfied and send the encoded video information that satisfies the predetermined condition to the storage medium.

35. The system of claim 34 wherein the predetermined condition comprises a threshold bit size per encoded frame.

36. The system of claim 34 wherein the predetermined condition comprises a minimum quality parameter.
